(19) United States
(12) Patent Application Publication
(10) Pub. No.: US 2024/0028019 A1
(43) Pub. Date: Jan. 25, 2024

(54) ANOMALY DETECTION USING TIME SERIES DATA

(71) Applicant: LYTT LIMITED, Middlesex (GB)

(72) Inventor: Pradyumna THIRUVENKATANATHAN, Twickenham, London (GB)

(73) Assignee: LYTT LIMITED, Middlesex (UK)

(21) Appl. No.: 18/024,494

(22) PCT Filed: Sep. 4, 2020
(86) PCT No.: PCT/EP2020/074876

§ 371 Date: Mar. 2, 2023

(51) Int. Cl. G05B 23/02

(52) U.S. Cl. CPC G05B 23/024; G05B 23/0221

(57) ABSTRACT

A method of identifying anomalies comprises determining, using a first data set, a baseline for one or more time series data components or features, determining, using a second data set, that one or more of the time series data components or features in the second data set exceed the baseline, providing, on a user interface, an indication of the one or more time series data components or features that exceed the baseline, receiving, using the user interface, feedback on the indication, and updating the baseline based on the feedback.

### CROSS-REFERENCE TO RELATED APPLICATIONS

This application is a 35 U.S.C. § 371 national stage application of PCT/EP2020/074876 filed Sep. 4, 2020, entitled “Anomaly Detection Using Time Series Data,” which is hereby incorporated herein by reference in its entirety for all purposes.

### STATEMENT REGARDING FEDERALLY SPONSORED RESEARCH OR DEVELOPMENT

Not applicable.

### BACKGROUND

Data is generated by instrumentation and sensors, for example, in chemical plants and wellbore environments. The data can generally be monitored by computers and personnel for any fluctuations and abnormalities in order to control the operation, for example, to react to alarms that are set off due to readings that exceed thresholds in plant or wellbore operation.

### SUMMARY

In some aspects, a method of identifying anomalies comprises determining, using a first data set, a baseline for one or more time series data components or features, determining, using a second data set, that one or more of the time series data components or features in the second data set exceed the baseline, providing, on a user interface, an indication of the one or more time series data components or features that exceed the baseline, receiving, using the user interface, feedback on the indication, and updating the baseline based on the feedback.

In some aspects, a method of identifying anomalies comprises: determining, using a first data set, a baseline for one or more time series data components or features, determining, using a second data set, that one or more of the time series data components or features in the second data set exceed the baseline, identifying a presence of one or more anomalies based on determining that the one or more of the time series data components or features in the second data set exceed the baseline, correlating the one or more of the time series data components or features in the second data set with historical data, identifying an event within the historical data based on the correlating, and presenting, on a user interface, an indication of the event.

In some aspects, a method of identifying events comprises: determining, using a first data set, one or more time series data components or features, determining a presence of an anomaly based on at least a first component or feature of the one or more time series data components or features and a baseline for the at least a first component or feature of the one or more time series data components or features, analyzing at least a second component or feature of the one or more time series data components or features in response to the determination of the presence of the anomaly, and determining an identity of an event using at least the second component or feature of the one or more time series data components or features.

In some aspects, a system for identifying anomalies in time series data comprises one or more sensors configured to measure one or more parameters of an environment and generate time series data, a processor configured to receive the time series data from the one or more sensors, a user interface coupled to the processor, a memory, and an analysis program stored on the memory. The analysis program is configured, when executed on the processor, to: determine, using a first data set of the time series data, a baseline for one or more time series data components or features, determine, using a second data set, that one or more of the time series data components or features in the second data set exceed the baseline, provide, on the user interface, an indication of the one or more time series data components or features that exceed the baseline, receiving, using the user interface, feedback on the indication, and updating the baseline based on the feedback.

Embodiments and aspects described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of the preferred embodiments of the invention, reference will now be made to the accompanying drawings in which:

FIG. 1 illustrates a schematic process flow for an anomaly detection process according to some embodiments; and

FIG. 2 illustrates a schematic diagram of a computer system that can implement the method of FIG. 1 according to some embodiments.

### DETAILED DESCRIPTION

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ” The various characteristics mentioned above, as well as other features and characteristics described in more detail below, will be readily apparent to those skilled in the art with the aid of this disclosure upon reading the following detailed description of the embodiments, and by referring to the accompanying drawings.

In some contexts, machine learning models can be applied to systems that collect data. These can include data analytic models that operate on stored data over time. An expert user may observe the data and provide the insights needed to analyze the data. For example, correlations between certain types of data can be provided by an expert user, and a model can then be constructed that uses the insights with the data. This process requires in initial set of insights and also tends to operate on stored data to provide the analysis well after the data has been obtained. These types of systems and arrangements cannot provide real time feedback, and they do not automatically provide insights into the data other than those initially identified by the experts.

Disclosed herein are methods and systems for detecting anomalies within time series data that may be obtained from suitable devices, systems, and/or signals, etc. such as sensor signals, inputs, control signals, and the like. Upon detection of an anomaly, further analysis may be performed by suitable system(s) and/or individual(s) (e.g., via expert analysis, machine-learning model, or combinations thereof) so as to provide a better understand of the environment (e.g., industrial plant, processing facilities, production facilities, wellbores, etc.) from which the time series data originated. However, by limiting further analysis to the detected anomalies, time and/or bandwidth utilized to analyze the time series data may be reduced, thereby improving the identification and response to events occurring within the environment that are associated with the detected anomaly (or anomalies).

The models and processes described herein can allow for any time series data in any setting that uses or obtains data (e.g., industrial settings, internet of things (IOT) systems, health systems, etc.) to be utilized to identify various events, and associated solutions. The time series data can be provided by a plurality of sensors. In some aspects, the system can perform correlations on the time series data and/or features derived from the time series data. The systems can also be used to observe the interaction of a plurality of users with the system to generate user feedback based on the presentation of data representative of the time series data. The correlations within the time series data and/or the feedback can then be used as an input into a machine learning model and/or used to label the data set used to train another machine learning model. The model can then be retrained over time to improve and/or identify new events. This can be seen as a self-learning and/or self-labeling system that can be used across a variety of industries where, during use, the system learns that certain detected anomalies correspond to an event within the environment of interest. This can improve a variety of systems by making the models more accurate, operate faster while potentially reducing or eliminating the need for any initial expert guidance on the relevant parameters or design of the models.

As used herein, the term “time series data” refers to data that is collected over time and can be labeled (e.g., timestamped) such that the particular time which the data value is collected is associated with the data value. “Time series data” can be displayed to a user and updated periodically to show new time series data along with historical time series data over a corresponding time period. Examples of time series data can include any sensor data over time, derivatives of sensor data, combinations of sensor data, model outputs derived from sensor data, or other time based data inputs, observed data (e.g., healthcare diagnosis, lab testing, etc.), or any other data entered over time.

As disclosed herein, time series data generated in various settings and environments can include data generated by a multitude of sensors or data entries. For example, most industrial plants contain many temperature sensors, pressure sensors, flow sensors, position sensors (e.g., to indicate the positioning of a valve, hatch, etc.), fluid level sensors, and the like. The resulting data can be used in various systems to determine parameters of the environment (or system disposed within the environment) such as a state of a unit (operating, filling, emptying, etc.), a type and flow rate of a fluid, fluid stream compositions, and the like, using various system models that can then also generate additional time series data (e.g., a fluid level determined from a plurality of other sensor data).

As used herein, an “anomaly” may comprise a statistically significant deviation from a baseline or normal condition within the time series data. More specifically, an anomaly may be associated with one or more features (e.g., frequency domain features, time domain features, etc.) of the time series data deviating beyond a defined range, envelope, or limit (e.g., a “variability threshold” as described below). The range or envelope of the one or more features of the time series data may correspond with the above-mentioned “baseline.” An anomaly does not correspond (at least initially) with a known or labeled “event” within the environment in question and may instead correspond to a potential and currently undefined event. Further analysis may be performed on the detected anomaly (e.g., by an expert, a system employing one or more machine-learning models, etc.) so as to confirm whether the detected anomaly is a confirmed anomaly or a false positive and to associate any confirmed anomalies with a labeled event or events within the environment. Thereafter, upon detecting the deviations associated with the previously identified and analyzed anomaly, the labeled event may be detected. This event detection may occur in real time or near real time.

As used herein an “event” can comprise any occurrence within the relevant setting that is determined based on an analysis of the time series data. Events can represent problems associated with systems or processes of the environment in question. For example, in some embodiments the environment in question may comprise a subterranean wellbore, and the time series data may comprise acoustic sensor data. In some of these embodiments, the acoustic data can be used to detect an event within the wellbore such as fluid inflow, sand influx, fluid outflow, etc. In some embodiments, the environment in question may comprise a transportation device, such as a train, the time series data may comprise sensor data associated with one or more wheels on the train (e.g., strain, vibration, acoustic, temperature, pressure, etc.). In some of these embodiments, the time series data may be used to detect an event that may comprise a failure or wearing in a bearing of one of the train wheels. In still another example, the environment in question may comprise the body of a patient, and the time series data may comprise various observations, measurements, and/or lab data obtained during a course of treatment for the patient. In some of these embodiments, an event (e.g., a condition, health problem, etc.) may be identified based on the time series data. In all of these example embodiments above, the various “events” may also correspond to or comprise an anomaly (or multiple anomalies) with respect to one or more features of the time series data (or the raw time series data itself). Thus, prior to identifying the particular features of the time series data as being associated with the “event,” the features may merely indicate that an anomaly has occurred that requires additional analysis as generally described above so as to potentially associate the identified anomaly with a particular event or events.

Thus, one can see that over time, as events are identified from the available time series data, fewer and fewer anomalies are detected. Eventually, only or substantially only events may be identified by the systems and methods described herein, and anomaly detection can be limited or phased out (or mostly phased out). The period of time associated with anomaly detection and correlation of anomalies to events may be referred to herein as a “learning period.”

The process described herein can comprise analyzing one or more features thereof as previously described above. Features can comprise one or more values or transformations determined from the time series data, where the time series data can comprise one or more sensor outputs (e.g., individual sensor outputs can be referred to as time series data components). For example, frequency analysis of various signals or time series data components can be performed by transforming a data sample into the frequency domain, using for example, a suitable Fourier transform. Other transformations such as combinations or data, mathematical transforms, and the like can be used to determine features from the time series data. In some embodiments, correlations between time series data components, other features, and/or anomalies and the like can be stored in the system as features (e.g., similarity scores, correlation scores, etc. can be features). The features can be determined using the time series data, and therefore can represent time series data themselves. The raw time series data and/or the features thereof can be used to determine anomalies or events as generally described above. For example, various threshold analyses, multivariate models, machine learning models, or the like can be used with the time series data and/or features as inputs to provide an output that is indicative of the presence of absence of an anomaly or event.

The methods and systems described herein can be used with a wide variety of sensor systems and environments. In general, the systems can be used with any field or programs that receive time series data. For example, hydrocarbon production facilities, pipelines, security settings, transportation systems, industrial processing facilities, chemical facilities, and the like can all use a variety of sensors or other devices that can produce timer series data. Similarly, repair and maintenance facilities that use a variety of testing apparatus across many maintenance personnel can benefit from the system. Similarly, the health care industry that receives large volumes of data on patients (that can be anonymized in most situations) across many health care providers can also use the disclosed systems to identify diagnostic workflows, health diagnoses, and appropriate treatment options across the patient base. Many other industries and fields can also use the systems disclosed herein. The resulting data can be used in various processing systems, and the systems and methods as described herein can be used with those systems to provide additional insights on the workflows of the users and related features that may not be intuitively related to most, if any, users of the systems. In any of these fields, the systems described herein can be used along with existing identification systems and data analysis programs to learn the workflows, improve the identification of anomalies, and provide solutions and predictive services.

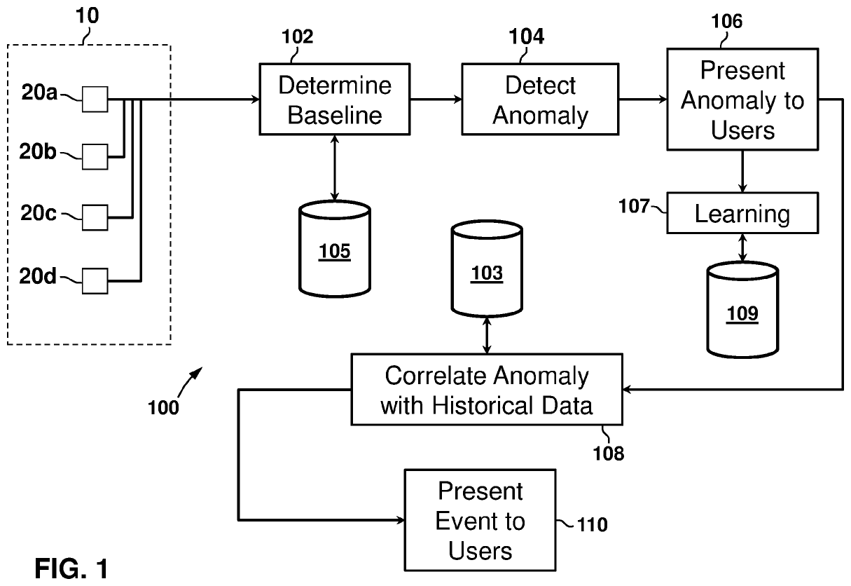

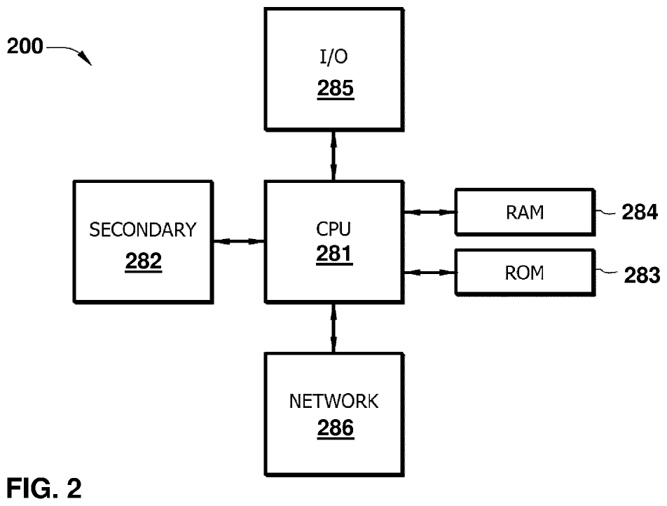

FIG. 1 illustrates a process 100 for identifying anomalies from time series data according to some embodiments. Generally speaking, method 100 may be employed to detect, identify, and/or verify anomalies in time series data generated within an environment 10 of interest. In some embodiments, some or all of the features of method 100 may be implemented as instructions stored on computer-readable medium (e.g., a memory) that may be executed by a processor to perform some of all of the functions, steps, etc. described below. For instance, in some embodiments, some or all of the features of method 100 may be practiced by a computer system 200 shown in FIG. 2 and described in more detail below.

The time series data may be obtained from one or more sensors 20 (e.g., such as sensors 20a, 20b, 20c, 20d) positioned within or adjacent to the environment 10. In some embodiments, the environment 10 may comprise a subterranean wellbore, a manufacturing facility, a transportation device (e.g., a train), the body of a patient, etc., and the sensors 20 (e.g., sensors 20a-20d) may measure or detect one or more parameters associated with the environment 10, such as, for instance, pressure, temperature, strain, acoustic energy, vibration, light, heart rate, blood pressure, etc. As an example, one or more of the sensors 20a-20d can be associated with a wellbore to allow for monitoring of the wellbore during production of hydrocarbon fluids to the surface. In this example, the sensors 20 (e.g., one or more of the sensors 20a-20d) can include temperature sensors, pressure sensors, vibration sensors, and the like.

In some embodiments, one or more of the sensors 20a-20d may comprise a distributed temperature sensor (DTS) that uses a fiber optic cable to detect a distributed temperature signal along the length of a subterranean wellbore. Similarly, in some embodiments, one or more of the sensors 20a-20d may comprise a distributed acoustic sensor (DAS) that uses a fiber optic cable to detect a distributed acoustic signal along the length of a wellbore. Additional sensors (e.g., of the sensors 20a-20d) can also be present in the wellbore and at the surface (e.g., flow sensors, fluid phase sensors, etc.).

Referring still to FIG. 1, at block 102, method 100 can include generating baseline identifications for the time series data and/or features associated with the time series data. Once the baseline values are determined, the baseline values can be stored in a baseline store 105 (e.g., which may comprise one or more memory devices). The baseline identifications may be carried out for a first data set of the time series data. As will be described in more detail below, anomaly detection (e.g., via block 104) may be carried out with a second set data set of the time series data. In some embodiments, the second data set may occur later in time than the first data set.

The baseline identifications generated at block 102 may comprise values of the time series data, or features associated therewith, that define a threshold, range, or envelope for identifying an anomaly for at least one time series data or component. For instance, a univariate sensor baseline identification can be established for output or measured values from a given sensor (e.g., a pressure sensor, temperature sensor, acoustic sensor, etc.) by taking a sample of the data over a sufficient time period such as over an hour, a day, a week, or a month. A statistical analysis of the data sample can be used to establish a baseline value (e.g., an average, median, etc.). In some embodiments, a variability threshold (e.g., a statistical variation over the time period) may also be developed to define a threshold, range, envelope, etc. about or relative to the baseline value. As is described in more detail below, the variability threshold may discern between variations in the baseline value that are due to noise in the time series data and variations that correspond with an anomaly.

In some embodiments, baseline identification may be determined for one or more of the components or features determined from the time series data. Specifically, in some embodiments, one or more functions or models may be used to produce features (such as statistical features) from the time series data provided from sensors 20a-20d. The time series data 50 can be pre-processed using various techniques such as denoising, filtering, and/or transformations to provide data that can be processed to provide the features.

In some embodiments, the features determined from the time series data may comprise one or more frequency domain features obtained from DAS data originating within a subterranean wellbore (e.g., the environment 10). In some of these embodiments, the frequency domain features may comprise one or more of a spectral centroid, a spectral spread, a spectral roll-off, a spectral skewness, a root mean square (RMS) band energy, a total RMS energy, a spectral flatness, a spectral slope, a spectral kurtosis, a spectral flux, a spectral autocorrelation function, or a normalized variant thereof.

In some embodiments, the features determined from the time series data may comprise one or more temperature features (e.g., statistical features through time and/or depth) obtained from DTS data originating within a wellbore. In some of these embodiments, the temperature features may comprise one or more of (including combinations, variants (e.g., a normalized variant), and/or transformations thereof) a depth derivative of temperature with respect to depth, a temperature excursion measurement, a baseline temperature excursion, a peak-to-peak value, an autocorrelation, a heat loss parameter, or a time-depth derivative, a depth-time derivative, or both. The temperature excursion measurement comprises a difference between a temperature reading at a first depth and a smoothed temperature reading over a depth range, wherein the first depth is within the depth range. The baseline temperature excursion comprises a derivative of a baseline excursion with depth, wherein the baseline excursion comprises a difference between a baseline temperature profile and a smoothed temperature profile. The peak-to-peak value comprises a derivative of a peak-to-peak difference with depth, wherein the peak-to-peak difference comprises a difference between a peak high temperature reading and a peak low temperature reading with an interval. The autocorrelation is a cross-correlation of the temperature signal with itself.

Regardless of whether the baseline identification is determined for the raw time series data components or a feature associated therewith as described above, the baseline identification at block 102 may comprise, in some embodiments, defining a baseline value and a variability threshold for the baseline value. As previously described above, the baseline value may comprise an average (e.g., a mean, etc.) or median value for the time series data and/or features associated therewith. In addition, in some embodiments, the variability threshold comprises an amount of variability in the data for the sensor 20a-20d in question. In some aspects, the variability threshold could represent a standard deviation, and/or a median absolute deviation (MAD) of the raw time series data or at least one feature associated therewith over a time period. The variability threshold can represent a combination of the baseline value along with an acceptable deviation from the baseline based or a variability within the sensor data at the location of the sensor (e.g., such as a sensor depth in situations where the environment 10 comprises a subterranean wellbore). Thus, the variability threshold can be determined for each of the sensors 20a-20d, for all of the sensors 20a-20b, and/or for a given application of the sensor.

The baseline identification can be defined in a number of ways including a univariate baseline, a multivariate baseline, or the like. A univariate baseline considers each variable (e.g., a sensor reading) individually. As an example, a representative data sample of sensor data for each data element can be taken over a representative time period. A statistical analysis can be performed on each data sample (e.g., a data sample from one of the sensors 20a-20d or a plurality of the sensors 20a-20d), and a baseline value, and potentially the variability threshold, can be determined for some or all of the data elements in the data sample (e.g., the raw time series data, features thereof, etc.).

In some embodiments, the sensor 20a may comprise a temperature sensor, the sensor 20b may comprise an accelerometer, and the sensor 20c may comprise a pressure sensor. A univariate sensor baseline can be established for each of the temperature values detected by sensor 20a, the accelerometer values detected by sensor 20b, and the pressure values detected by sensor 20c by taking a sample of the data over a sufficient time period such as over an hour, a day, a week, or a month. A statistical analysis of each data sample can be used to establish a baseline value (e.g., an average, median, etc.) along with an optional variability measurement (e.g., a standard deviation, and/or a MAD) for each data sample (e.g., the data sample associated with each sensor 20a, 20b, 20c). Thus, in this example, a baseline can then be established for each of the temperature readings, the accelerometer readings, and the pressure readings. During operation of the system, when a temperature reading from sensor 20a exceeds the temperature baseline value, and optionally exceeds a variability threshold, an indication of an anomaly can be generated. This can occur even if the accelerometer readings from sensor 20b and the pressure readings from sensor 20c remain within the baseline values and variability thresholds.

In some aspects, the baseline identification can be based on a multivariate sensor baseline analysis. A multivariate baseline can consider two or more variables (e.g., multiple sensor readings) in combination. A multivariate base can include looking at two or more of the time series data elements and/or features together, including in some aspects, using all of the time series data and/or feature elements. The grouped data used within the multivariate analysis can be referred to as a multivariate data set. As an example, representative data samples of sensor data (e.g., from sensors 20a-20d) for each data element can be taken over a representative time period. A multivariate statistical analysis can be performed on the data samples within the multivariate analysis together, and a baseline value along with an optional variability measurement can be determined for the multivariate data set of time series data and/or features associated therewith. Various pre-processing can be performed on the data as part of the statistical analysis. For example, each data sample (e.g., each data sample from a given sensor 20a, 20b, 20c, 20d) can be denoised prior to be analyzed as part of the baseline determination. During operation, the data samples can be provided as a multivariate data set and compared to the multivariate baseline. An excursion from the multivariate baseline of the time series data and/or feature value that exceeds the baseline value and/or exceeds the baseline value considering an allowable variability can then be considered to represent an anomaly in the data, which can be further analyzed.

In the example previously described above, the sensor 20a may comprise a temperature sensor, the sensor 20b may comprise an accelerometer, and the sensor 20c may comprise a pressure sensor. A multivariate baseline can be established for the combination of the temperature values detected by sensor 20a, the accelerometer values detected by sensor 20b, and the pressure values detected by sensor 20c by taking sample of the data over a sufficient time period such as over an hour, a day, a week, or a month. The sample data sets can be analyzed using a multivariate statistical analysis of the multivariate data set to establish a single baseline value (e.g., an average, median, etc.) along with an optional variability measurement (e.g., a standard deviation, and/or a MAD) for some or all of the data samples provided from sensors 20a, 20b, 20c. Thus, in this example, a baseline can then be established for the multivariate data set as a whole. During operation of the system, when a temperature reading from sensor 20a changes, the multivariate baseline would be used to determine if the multivariate data set exceeds the multivariate baseline. Since the multivariate data set is based on a plurality of variables, it is possible that a temperature value from sensor 20a that could trigger an anomaly indication in a univariate baseline analysis may not trigger an anomaly detection under the multivariate baseline because the multivariate baseline defines a threshold dependent on all of the variable and not just one. For example, an increased temperature (e.g., via sensor 20a) may be acceptable with a decrease in pressure (e.g., via senor 20c), and the multivariate baseline could take the change in both variables into consideration in determining whether or not an anomaly has occurred.

Referring still to FIG. 1, at block 104, anomaly detection can be carried out on the data being monitored using the baselines in the baseline store 105. Specifically, as previously described above, anomaly detection via block 104 may be carried out on a second data set of the time series data that may occur later in time than the first data set of the time series data utilized for baseline identification at block 102. An anomaly can be detected at block 104 by comparing the time series data and/or features that define the baseline (e.g., the first data set) with the corresponding time series data and/or features obtained from the data being measured (e.g., the second data set). The anomaly detection can be carried out for a single time series data component and/or features, or a plurality of time series data components and/or features. As previously described, the second data set and the first data set may comprise output data from the sensors 20a-20d. By monitoring the data obtained across a plurality of sensors 20a-20d relative to the baseline definitions obtained at block 102, an anomaly can be detected within the environment 10 being monitored.

During this process, the time series data provided by one or more of the sensors 20a-20d can be monitored. If any transformations or derivations of the time series data (or features thereof) are used to define the baseline at block 102 (e.g., a univariate baseline, a multivariate baseline, or combinations thereof), the corresponding transformations or derivations can be determined and compared with the baseline definitions to determine if an excursion outside of an allowable limit or threshold has occurred. The anomaly detection may provide a simple indication that a threshold or limit has been exceeded, which can trigger a further analysis. In general, the anomaly can then represent the occurrence of one or more events based on a signal being detected that is above a background noise level (e.g., as measured by at least one time series data component and/or feature). While the anomaly detection can provide an indication that some event has occurred, the anomaly detection itself may not provide an identification of the event without further analysis. In some embodiments, the anomaly detection can provide an indication of an amount of excursion from the baseline to provide an indication of the severity of the event, which can be used to determine a level of notification of the anomaly (e.g., a notification, an alert, an alarm, etc.).

Once an anomaly is identified at block 104, the anomaly can be provided to the system to allow an alert to be provided on a user interface (e.g., an electronic display unit) in block 806. For example, on the user interface: a portion of the data can be highlighted, an alert can be displayed, and/or a window can be opened to show the anomaly. The generation of the alert can serve to allow the user to select or identify additional time series data components and/or features to display along with the indication of the anomaly. A user may provide feedback on the user interface via any suitable method (e.g., by making selections, deleting subsets of the displayed data, etc.) that may indicate whether the anomaly identified at block 104 is a confirmed anomaly or is a false positive, which can be based on the anomaly data alone or in combination with additional time series data components and/or features that are displayed. For example, the anomaly detection can be used to trigger an additional analysis of other time series data components and/or features to allow the event to be identified and/or located.

In some aspects, a learning algorithm can be used at block 107 to monitor the user feedback from the user interface to learn if the anomaly is a confirmed anomaly or is a false positive. For example, if the user feedback directly indicates (e.g., via menu selection, command, etc.) or indirectly indicates (e.g., by selecting the anomaly for further analysis) that the anomaly is of interest, then the learning algorithm can designate the detected anomaly as a confirmed anomaly within the environment 10. Conversely, if the user feedback directly indicates (e.g., again via menu selection, command, etc.) or indirectly indicates (e.g., by closing a window presenting the anomaly, ignores the anomaly, etc.) that the anomaly is not of interest, then the learning algorithm may designate the detected anomaly as a false positive. Various learning algorithms such as a reinforcement learning algorithm can be used at block 107 to establish a correlation between the detected anomaly and previously identified false positives. Identifying information about the detected anomalies and the designations applied by the learning algorithm may be placed in storage 109 (which may comprise one or more memory devices). Thus, the learning algorithm may consult storage 109 to determine whether the detected anomaly was previously identified as a false positive or as a confirmed anomaly by a user.

In some embodiments, if the detected anomaly is determined to be a false positive, method 100 may comprise updating the baseline (e.g., the base line value and/or the variability threshold) so as to avoid detecting that particular false positive in subsequently obtained time series data. For example, a variability threshold may be updated to broaden the range of values of the time series data components and/or features that can be considered to be within the background noise. As a result, over time, the baseline identification may be updated so as to reduce a number of false positives that may be detected via blocks 102 and 104. In some embodiment, the previously noted reinforcement learning algorithm may be used to determine a change in the baseline so as to avoid a subsequent detection of the false positive.

When an anomaly is designated as a confirmed anomaly (e.g., via the learning at block 107 as previously described), the data associated with the anomaly can be obtained and examined to identify an event or problem associated with the anomaly at block 108. The data associated with the anomaly can include additional time series data components and/or features that are derived from the data but that are not used as part of the anomaly detection. In some aspects, the data associated with the anomaly can include time series data that extends across a length or depth. The data associated with the anomaly can then be correlated across time and/or length (e.g., depth) to identify events occurring at the identified anomaly and/or elsewhere within the data. This can occur using a feature analysis process and/or a matching process with historical data. For a feature analysis process, one or more features, including any of the time series data components and/or features associated therewith, can be used with one or more signatures and/or machine learning models to identify one or more events. Various signatures and/or machine learning models can be used with the time series data and/or features as inputs to provide an indication of the presence of one of a plurality of events.

Through time, when a confirmed anomaly is identified as being associated with an event, the system may use the event identification without flagging the anomaly. In some aspects, the detection of the anomaly can trigger an analysis using various time series data components and/or features (e.g., time series data components and/or features that are in addition to, or different from, those used for the anomaly detection) to identify the event. If the event can be identified, then the anomaly may be presented as the event rather than an anomaly. If the event cannot be identified, then the anomaly may be presented on the basis that no known event can be correlated to the time series data. Any anomalies then identified by the system may represent unidentified events. This may allow the system to only flag occurrences that need further investigation by a user. As an example in the wellbore context, an anomaly may initially be identified as a confirmed anomaly. Further analysis and confirmation from a user may associate the anomaly with a sand ingress event. When the anomaly occurs at a later time, the anomaly may be identified to a user as a sand ingress event rather than as an anomaly.

As an example, an anomaly detection process can involve monitoring a wellbore. Initially, a variety of sensor data can be obtained from the wellbore such as downhole pressure, production choke settings, wellhead pressure, acoustic data, and temperature data. As part of the anomaly detection, the downhole pressure can be monitored relative to a baseline and variability threshold. When a downhole pressure that changes outside of the baseline and variability threshold occurs, an anomaly can be indicated by the system. The change in downhole pressure alone may not represent enough information identify an event. In order to identify one or more events, additional data can be analyzed. The anomaly can then be presented to the user on the user interface, and the user can provide feedback by selecting one or more additional time series data components or features for display such as temperature and acoustic measurements and/or features. The additional data can then be used to identify the event associated with the downhole pressure anomaly. In this example, the feedback can be provided for time series data components or features (e.g., the temperature and acoustic measurements and/or features) rather than only for the measurements used to identify the anomaly.

In some aspects, a historical matching process can be used to identify an event associated with the anomaly. In this aspect, the time series data and/or features associated therewith can be used in a model to identify similar events occurring in the past. The past event information can be stored in a history store 103. A matching algorithm can then be used to identify the closest events in the history store 103 to the data related to the anomaly. The data related to the anomaly can include the data used to identify the anomaly and/or other time series data components and/or features obtained at the same time and location as the detected anomaly. The history store 103 can include event identifications that are provided by one or more machine learning models and/or user identifications or validations. This type of matching may provide for an identification of the event based on verified data from past occurrences.

In some embodiments, the historical matching process can comprise identifying an event that is associated with a plurality of detected anomalies. In addition, in some embodiments, the historical matching process can comprise identifying a plurality of events that are associated with a detected anomaly.

Once the event has been identified, historical parameters can also be identified for the event. The historical parameters can include solutions, responses, time to failure, related events that can follow in time, or any combination thereof. In some aspects, the historical information can include a time to failure if no action is taken. This can allow for a determination of a maintenance process or schedule needed to prevent a failure associated with the event. This predictive maintenance can be used to help to identify anomalies and potential problems along with the solution needed to prevent the failure of systems in industrial settings.

Once the event has been identified, the event and/or the historical parameters associated with the event can be presented to a user on the user interface at block 110. The user can select the event identification and potentially the solutions, maintenance needs, and the like to find a resolution to the occurrence of the event. When predictive maintenance or other actions are identified, the actions can be carried out to resolve the event. Upon the resolution of the event, the anomaly can be resolved.

In some embodiments, if an anomaly, plurality of anomalies, or the associated time series data components and/or features have not been matched or associated with a known event at block 108, then method 100 may comprise presenting the un-matched anomalies to the use via a user interface as unidentified anomalies. The presentation of unidentified anomalies may occur along with the presentation of the identified events at block 110. By presenting the unidentified anomalies to the user, further analysis by the user and/or another system (which may employ additional models, algorithms, etc.) so as to characterize the unidentified anomalies as one or more events within the environment 10. Once these events are identified, the events (or data representative of the events) may be stored in storage 103 (or other suitable location) such that subsequent performances of method 100 may identify these events based on corresponding anomalies as described herein.

Any of the systems and methods disclosed herein can be carried out on a computer or other device comprising a processor. FIG. 2 illustrates a computer system 200 suitable for implementing one or more embodiments disclosed herein such as the method 100 or a system for performing method or any portion thereof. The computer system 200 includes a processor 282 (which may be referred to as a central processor unit or CPU) that is in communication with memory devices including secondary storage 284, read only memory (ROM) 286, random access memory (RAM) 288, input/output (I/O) devices 290, and network connectivity devices 292. The processor 282 may be implemented as one or more CPU chips.

It is understood that by programming and/or loading executable instructions onto the computer system 200, at least one of the CPU 282, the RAM 288, and the ROM 286 are changed, transforming the computer system 200 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 200 is turned on or booted, the CPU 282 may execute a computer program or application. For example, the CPU 282 may execute software or firmware stored in the ROM 286 or stored in the RAM 288. In some cases, on boot and/or when the application is initiated, the CPU 282 may copy the application or portions of the application from the secondary storage 284 to the RAM 288 or to memory space within the CPU 282 itself, and the CPU 282 may then execute instructions that the application is comprised of In some cases, the CPU 282 may copy the application or portions of the application from memory accessed via the network connectivity devices 292 or via the I/O devices 290 to the RAM 288 or to memory space within the CPU 282, and the CPU 282 may then execute instructions that the application is comprised of. During execution, an application may load instructions into the CPU 282, for example load some of the instructions of the application into a cache of the CPU 282. In some contexts, an application that is executed may be said to configure the CPU 282 to do something, e.g., to configure the CPU 282 to perform the function or functions promoted by the subject application. When the CPU 282 is configured in this way by the application, the CPU 282 becomes a specific purpose computer or a specific purpose machine.

The secondary storage 284 is typically comprised of one or more disk drives or tape drives and is used for non-volatile storage of data and as an over-flow data storage device if RAM 288 is not large enough to hold all working data. Secondary storage 284 may be used to store programs which are loaded into RAM 288 when such programs are selected for execution. The ROM 286 is used to store instructions and perhaps data which are read during program execution. ROM 286 is a non-volatile memory device which typically has a small memory capacity relative to the larger memory capacity of secondary storage 284. The RAM 288 is used to store volatile data and perhaps to store instructions. Access to both ROM 286 and RAM 288 is typically faster than to secondary storage 284. The secondary storage 284, the RAM 288, and/or the ROM 286 may be referred to in some contexts as computer readable storage media and/or non-transitory computer readable media.

I/O devices 290 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 292 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 292 may enable the processor 282 to communicate with the Internet or one or more intranets. With such a network connection, it is contemplated that the processor 282 might receive information from the network, or might output information to the network (e.g., to an event database) in the course of performing the above-described method steps. Such information, which is often represented as a sequence of instructions to be executed using processor 282, may be received from and outputted to the network, for example, in the form of a computer data signal embodied in a carrier wave.

Such information, which may include data or instructions to be executed using processor 282 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 282 executes instructions, codes, computer programs, scripts which it accesses from hard disk, floppy disk, optical disk (these various disk based systems may all be considered secondary storage 284), flash drive, ROM 286, RAM 288, or the network connectivity devices 292. While only one processor 282 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 284, for example, hard drives, floppy disks, optical disks, and/or other device, the ROM 286, and/or the RAM 288 may be referred to in some contexts as non-transitory instructions and/or non-transitory information.

In an embodiment, the computer system 200 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 200 to provide the functionality of a number of servers that is not directly bound to the number of computers in the computer system 200. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 200, at least portions of the contents of the computer program product to the secondary storage 284, to the ROM 286, to the RAM 288, and/or to other non-volatile memory and volatile memory of the computer system 200. The processor 282 may process the executable instructions and/or data structures in part by directly accessing the computer program product, for example by reading from a CD-ROM disk inserted into a disk drive peripheral of the computer system 200. Alternatively, the processor 282 may process the executable instructions and/or data structures by remotely accessing the computer program product, for example by downloading the executable instructions and/or data structures from a remote server through the network connectivity devices 292. The computer program product may comprise instructions that promote the loading and/or copying of data, data structures, files, and/or executable instructions to the secondary storage 284, to the ROM 286, to the RAM 288, and/or to other non-volatile memory and volatile memory of the computer system 200.

In some contexts, the secondary storage 284, the ROM 286, and the RAM 288 may be referred to as a non-transitory computer readable medium or a computer readable storage media. A dynamic RAM embodiment of the RAM 288, likewise, may be referred to as a non-transitory computer readable medium in that while the dynamic RAM receives electrical power and is operated in accordance with its design, for example during a period of time during which the computer system 200 is turned on and operational, the dynamic RAM stores information that is written to it. Similarly, the processor 282 may comprise an internal RAM, an internal ROM, a cache memory, and/or other internal non-transitory storage blocks, sections, or components that may be referred to in some contexts as non-transitory computer readable media or computer readable storage media.

Having described various systems and methods, certain aspects can include, but are not limited to:

In a first aspect, a method of identifying anomalies comprises: determining, using a first data set, a baseline for one or more time series data components or features; determining, using a second data set, that one or more of the time series data components or features in the second data set exceed the baseline; providing, on a user interface, an indication of the one or more time series data components or features that exceed the baseline; receiving, using the user interface, feedback on the indication; and updating the baseline based on the feedback.

A second aspect can include the method of the first aspect, wherein determining the baseline comprises determining a univariate baseline for each of the one or more time series data components or features.

A third aspect can include the method of the second aspect, wherein determining that one or more of the time series data components or features in the second data set exceed the baseline comprises: comparing each time series data component and feature in the second data set with a corresponding value in the baseline, and determining that at least one of the time series data components or features in the second data set exceeds the corresponding value in the baseline.

A fourth aspect can include the method of any one of the first to third aspects, wherein determining the baseline comprises: determining a multivariate baseline for a plurality of the one or more time series data components or features.

A fifth aspect can include the method of the fourth aspect, wherein determining that one or more of the time series data components or features in the second data set exceed the baseline comprises: comparing a plurality of the time series data component or feature in the second data set with the multivariate baseline, and determining that the plurality of the time series data components or features exceeds the multivariate baseline.

A sixth aspect can include the method of any one of the first to fifth aspects, wherein updating the baseline comprises using a reinforcement learning model to update the baseline.

A seventh aspect can include the method of any one of the first to sixth aspects, further comprising: providing, on the user interface, an indication of at least one additional time series data component or feature, wherein the feedback is related to the at least one additional time series data component or feature.

In an eighth aspect, a method of identifying anomalies comprises: determining, using a first data set, a baseline for one or more time series data components or features; determining, using a second data set, that one or more of the time series data components or features in the second data set exceed the baseline; identifying a presence of one or more anomalies based on determining that the one or more of the time series data components or features in the second data set exceed the baseline; correlating the one or more of the time series data components or features in the second data set with historical data; identifying an event within the historical data based on the correlating; and presenting, on a user interface, an indication of the event.

A ninth aspect can include the method of the eighth aspect, further comprising presenting, on the user interface, one or more historical parameters associated with the event.

A tenth aspect can include the method of the ninth aspect, wherein the historical parameters comprise at least one of a solution to the event, a response to the event, a time to failure, a related event associated with the event, or any combination thereof.

An eleventh aspect can include the method of the ninth aspect, wherein the historical parameters comprise a maintenance process, wherein the maintenance process is configured to prevent a failure resulting from the event.

A twelfth aspect can include the method of any one of the eighth to eleventh aspects, wherein determining the baseline comprises determining a univariate baseline for each of the one or more time series data components or features.

A thirteenth aspect can include the method of the twelfth aspect, wherein determining that one or more of the time series data components or features in the second data set exceed the baseline comprises: comparing each time series data component and feature in the second data set with a corresponding value in the baseline, and determining that at least one of the time series data components or features in the second data set exceeds the corresponding value in the baseline.

A fourteenth aspect can include the method of any one of the eighth to thirteenth aspects, wherein determining the baseline comprises determining a multivariate baseline for a plurality of the one or more time series data components or features.

A fifteenth aspect can include the method of the fourteenth aspect, wherein determining that one or more of the time series data components or features in the second data set exceed the baseline comprises: comparing a plurality of the time series data component or feature in the workflow neighbor in the second data set with the multivariate baseline, and determining that the plurality of the time series data components or features exceeds the multivariate baseline.

A sixteenth aspect can include the method of any one of the eighth to fifteenth aspects, further comprising: providing, on a user interface, an indication of the one or more time series data components or features that exceed the baseline; receiving, using the user interface, feedback on the indication; and updating the baseline based on the feedback.

A seventeenth aspect can include the method of the sixteenth aspect, wherein updating the baseline comprises using a reinforcement learning model to update the base.

An eighteenth aspect can include the method of any one of the eighth to seventeenth aspects, further comprising: correlating the event with at least one anomaly of the one or more anomalies; removing the at least one anomaly from the one or more anomalies to identify one or more remaining anomalies; and presenting, on the user interface, the one or more remaining anomalies as unidentified anomalies.

A nineteenth aspect can include the method of any one of the eighth to eighteenth aspects, wherein identifying the presence of the one or more anomalies is based on a first feature of the one or more of the time series data components or features, and wherein identifying the event is based on at least a second feature of the one or more of the time series data components.

In a twentieth aspect, a method of identifying events comprises: determining, using a first data set, one or more time series data components or features; determining a presence of an anomaly based on at least a first component or feature of the one or more time series data components or features and a baseline for the at least a first component or feature of the one or more time series data components or features; analyzing at least a second component or feature of the one or more time series data components or features in response to the determination of the presence of the anomaly; and determining an identity of an event using at least the second component or feature of the one or more time series data components or features.

In a twenty first aspect, a system for identifying anomalies in time series data comprises: one or more sensors configured to measure one or more parameters of an environment and generate time series data; a processor configured to receive the time series data from the one or more sensors; a user interface coupled to the processor; a memory; and an analysis program stored on the memory, wherein the analysis program is configured, when executed on the processor, to: determine, using a first data set of the time series data, a baseline for one or more time series data components or features; determine, using a second data set, that one or more of the time series data components or features in the second data set exceed the baseline; provide, on the user interface, an indication of the one or more time series data components or features that exceed the baseline; receiving, using the user interface, feedback on the indication; and updating the baseline based on the feedback.

A twenty second aspect can include the system of the twenty first aspect, wherein the analysis program is configured, when executed on the processor, to determine the baseline by determining a univariate baseline for each of the one or more time series data components or features.

A twenty third aspect can include the system of the twenty second aspect, wherein the analysis program is configured, when executed on the processor, to determine that one or more of the time series data components or features in the second data set exceed the baseline by: comparing each time series data component and feature in the second data set with a corresponding value in the baseline, and determining that at least one of the time series data components or features in the second data set exceeds the corresponding value in the baseline.

A twenty fourth aspect can include the system of any one of the twenty first to twenty third aspects, wherein the analysis program is configured, when executed on the processor, to determine the baseline by determining a multivariate baseline for a plurality of the one or more time series data components or features.

A twenty fifth aspect can include the system of the twenty fourth aspect, wherein the analysis program is configured, when executed on the processor, to determine that one or more of the time series data components or features in the second data set exceed the baseline by: comparing a plurality of the time series data component or feature in the second data set with the multivariate baseline, and determining that the plurality of the time series data components or features exceeds the multivariate baseline.

A twenty sixth aspect can include the system of any one of the twenty first to twenty fifth aspects, wherein the analysis program is configured, when executed on the processor, to update the baseline using a reinforcement learning model.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. For example, features described as method steps may have corresponding elements in the system embodiments described above, and vice versa. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A method of identifying anomalies, the method comprising:
determining, using a first data set, a baseline for one or more time series data components or features;
determining, using a second data set, that one or more of the time series data components or features in the second data set exceed the baseline;
providing, on a user interface, an indication of the one or more time series data components or features that exceed the baseline;
receiving, using the user interface, feedback on the indication; and
updating the baseline based on the feedback.

2. The method of claim 1, wherein determining the baseline comprises determining a univariate baseline for each of the one or more time series data components or features.

3. The method of claim 2, wherein determining that one or more of the time series data components or features in the second data set exceed the baseline comprises:
comparing each time series data component and feature in the second data set with a corresponding value in the baseline, and
determining that at least one of the time series data components or features in the second data set exceeds the corresponding value in the baseline.

4. The method of claim 1, wherein determining the baseline comprises: determining a multivariate baseline for a plurality of the one or more time series data components or features.

5. The method of claim 4, wherein determining that one or more of the time series data components or features in the second data set exceed the baseline comprises:
comparing a plurality of the time series data component or feature in the second data set with the multivariate baseline, and
determining that the plurality of the time series data components or features exceeds the multivariate baseline.

6. The method of claim 1, wherein updating the baseline comprises using a reinforcement learning model to update the baseline.

7. The method of claim 1, further comprising: providing, on the user interface, an indication of at least one additional time series data component or feature, wherein the feedback is related to the at least one additional time series data component or feature.

8. A method of identifying anomalies, the method comprising:
determining, using a first data set, a baseline for one or more time series data components or features;
determining, using a second data set, that one or more of the time series data components or features in the second data set exceed the baseline;
identifying a presence of one or more anomalies based on determining that the one or more of the time series data components or features in the second data set exceed the baseline;
correlating the one or more of the time series data components or features in the second data set with historical data;
identifying an event within the historical data based on the correlating; and
presenting, on a user interface, an indication of the event.

9. The method of claim 8, further comprising presenting, on the user interface, one or more historical parameters associated with the event.

10. The method of claim 9, wherein the historical parameters comprise at least one of a solution to the event, a response to the event, a time to failure, a related event associated with the event, or any combination thereof.

11. The method of claim 9, wherein the historical parameters comprise a maintenance process, wherein the maintenance process is configured to prevent a failure resulting from the event.

12. The method of claim 8, wherein determining the baseline comprises determining a univariate baseline for each of the one or more time series data components or features.

13. The method of claim 12, wherein determining that one or more of the time series data components or features in the second data set exceed the baseline comprises:
comparing each time series data component and feature in the second data set with a corresponding value in the baseline, and
determining that at least one of the time series data components or features in the second data set exceeds the corresponding value in the baseline.

14. The method of claim 8, wherein determining the baseline comprises determining a multivariate baseline for a plurality of the one or more time series data components or features.

15. The method of claim 14, wherein determining that one or more of the time series data components or features in the second data set exceed the baseline comprises:
comparing a plurality of the time series data component or feature in the workflow neighbor in the second data set with the multivariate baseline, and
determining that the plurality of the time series data components or features exceeds the multivariate baseline.

16. The method of claim 8, further comprising:
providing, on a user interface, an indication of the one or more time series data components or features that exceed the baseline;
receiving, using the user interface, feedback on the indication; and
updating the baseline based on the feedback.

17. The method of claim 16, wherein updating the baseline comprises using a reinforcement learning model to update the base.

18. The method of claim 8, further comprising:
correlating the event with at least one anomaly of the one or more anomalies;
removing the at least one anomaly from the one or more anomalies to identify one or more remaining anomalies; and
presenting, on the user interface, the one or more remaining anomalies as unidentified anomalies.

19. The method of claim 8, wherein identifying the presence of the one or more anomalies is based on a first feature of the one or more of the time series data components or features, and wherein identifying the event is based on at least a second feature of the one or more of the time series data components.

20. A method of identifying events, the method comprising:
determining, using a first data set, one or more time series data components or features;
determining a presence of an anomaly based on at least a first component or feature of the one or more time series data components or features and a baseline for the at least a first component or feature of the one or more time series data components or features;
analyzing at least a second component or feature of the one or more time series data components or features in response to the determination of the presence of the anomaly; and
determining an identity of an event using at least the second component or feature of the one or more time series data components or features.

21. A system for identifying anomalies in time series data, the system comprising:
one or more sensors configured to measure one or more parameters of an environment and generate time series data;
a processor configured to receive the time series data from the one or more sensors;
a user interface coupled to the processor;
a memory; and
an analysis program stored on the memory, wherein the analysis program is configured, when executed on the processor, to:
determine, using a first data set of the time series data, a baseline for one or more time series data components or features;
determine, using a second data set, that one or more of the time series data components or features in the second data set exceed the baseline;
provide, on the user interface, an indication of the one or more time series data components or features that exceed the baseline;
receiving, using the user interface, feedback on the indication; and
updating the baseline based on the feedback.

22. The system of claim 21, wherein the analysis program is configured, when executed on the processor, to determine the baseline by determining a univariate baseline for each of the one or more time series data components or features.

23. The system of claim 22, wherein the analysis program is configured, when executed on the processor, to determine that one or more of the time series data components or features in the second data set exceed the baseline by:
comparing each time series data component and feature in the second data set with a corresponding value in the baseline, and
determining that at least one of the time series data components or features in the second data set exceeds the corresponding value in the baseline.

24. The system of claim 21, wherein the analysis program is configured, when executed on the processor, to determine the baseline by determining a multivariate baseline for a plurality of the one or more time series data components or features.

25. The system of claim 24, wherein the analysis program is configured, when executed on the processor, to determine that one or more of the time series data components or features in the second data set exceed the baseline by:
comparing a plurality of the time series data component or feature in the second data set with the multivariate baseline, and
determining that the plurality of the time series data components or features exceeds the multivariate baseline.

26. The method of claim 21, wherein the analysis program is configured, when executed on the processor, to update the baseline using a reinforcement learning model.
